(19) United States
(12) Patent Application Publication
(10) Pub. No.: US 2012/0066478 A1
(43) Pub. Date: Mar. 15, 2012

(54) METHOD FOR FAST PARALLEL INSTRUCTION LENGTH DETERMINATION

(76) Inventor: Robert B. Cohen, Austin, TX (US)

(21) Appl. No.: 12/878,456

(22) Filed: Sep. 9, 2010

(51) Int. Cl. G06F 9/312

(52) U.S. Cl. 712/205; 712/E09.033

(57) ABSTRACT

The present invention provides a method and apparatus that may be used for parallel instruction length decoding. One embodiment of the method includes concurrently determining a plurality of masks identifying bytes in a plurality of candidate instructions. Each mask uses a different byte in a first fetch window as a starting byte and the corresponding one of the plurality of candidate instructions includes the starting byte. This embodiment of the method also includes selecting one of the masks to identify one of the candidate instructions as a first instruction using information indicating an ending byte of a previous instruction.

### BACKGROUND OF THE INVENTION

1. Field of the Invention

This invention relates generally to processor systems, and, more particularly, to determining instruction lengths in processor systems.

2. Description of the Related Art

Processors are typically designed using a pipeline architecture that divides the processing of each computer instruction into a series of independent steps. For example, a processor pipeline can be divided into an instruction fetch stage during which instructions are retrieved from memories or caches, an instruction decode stage in which the instructions are decoded, an execution stage in which the decoded instructions are executed, and a write-back stage in which the information generated during execution is written back into memory. Each stage is typically separated by a set of flip flops for storing the output of the stage so that it can be used as input to the next stage during a subsequent clock cycle. Pipelining can improve the efficiency of processors significantly but it requires a high degree of coordination because each stage is typically operating on a different instruction during each clock cycle. Stalls, branch delays, timing errors, and the like can all disrupt a pipelined architecture and reduce its efficiency.

One well known X86 timing problem occurs when the instruction decode stage attempts to decode the instruction length for the instruction that is being decoded. One approach is to compute the length of the instructions and store markers that label instruction endpoints (end bits) in local caches (L1/L2). The next time the instructions are read in, e.g., within a fetch window, the previously calculated end bits are used to multiplex the predicted instruction from the fetch window to the instruction decoders. One of the tasks of the instruction decoders is to check that the cached length of the instruction is still valid for the actual instruction in the fetch window. If it is not still valid, then there is a stall and local redirect while the instruction decoder handles the exception, fetches the appropriate bytes that correspond to the correct length, and sends an end bit update to the instruction cache so that the local caches can be corrected. This mechanism was used to increase frequencies of operation with the ability to dispatch 3 or more instructions concurrently from the instruction decoder.

In order to store the instruction length information, caches must be available to hold the end bits. Moreover, the instruction decode stage needs to implement interim storage and/or circuitry to manage and update end bits during normal operation as well as during stalls that occur when the actual instruction does not correspond to the previously stored instruction length information. The instruction decode stage must also be able to perform the initial training so that it can detect instruction length information mismatches. When a mismatch is detected, the instruction decode stage can begin routing instructions based on an actual length decode instead of using the end bits stored in the cache. After performing the length decode of the instruction, the end bits in the cache can be updated and the instruction decode stage can transition back to using the cached end bits. In some cases, this functionality can be implemented using a normal operating mode when the stored instruction length is correct and an alternate mode when a mismatch is detected. Furthermore, because of the potential mismatch between the stored instruction length and the actual instruction, the actual instruction is not guaranteed to be resident in decoder prior to evaluation in the instruction decoders.

### SUMMARY OF EMBODIMENTS OF THE INVENTION

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a method is provided that may be used for parallel instruction length decoding. One embodiment of the method includes concurrently determining a plurality of masks identifying bytes in a plurality of candidate instructions. Each mask uses a different byte in a first fetch window as a starting byte and the corresponding one of the plurality of candidate instructions includes the starting byte. This embodiment of the method also includes selecting one of the masks to identify one of the candidate instructions as a first instruction using information indicating an ending byte of a previous instruction.

In another embodiment, a method is provided that may be used for parallel instruction length decoding. One embodiment of the apparatus includes a plurality of length decoders configured to concurrently determine a plurality of masks identifying bytes in a plurality of candidate instructions. Each of the plurality of masks uses a different byte in a first fetch window as a starting byte and the corresponding one of the plurality of candidate instructions includes the starting byte. This embodiment of the apparatus also includes a first multiplexer configured to select one of the masks to identify one of the candidate instructions as a first instruction using information indicating an ending byte of a previous instruction.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates one exemplary embodiment of a processing pipeline;

FIGS. 2A and 2B conceptually illustrate exemplary embodiments of a first stage and a second stage of an instruction length decoder;

FIG. 3A conceptually illustrates input and output for a bank or array of accumulators such as the accumulators shown in FIG. 2A.

FIG. 3B conceptually illustrates generation of relative start masks using the fetch window;

FIG. 3C conceptually illustrates selection of the start masks using information provided by a generator, such as the generator shown in FIG. 2B; and

FIG. 3D conceptually illustrates selection of the start masks using information provided by a generator, such as the generator shown in FIG. 2B.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

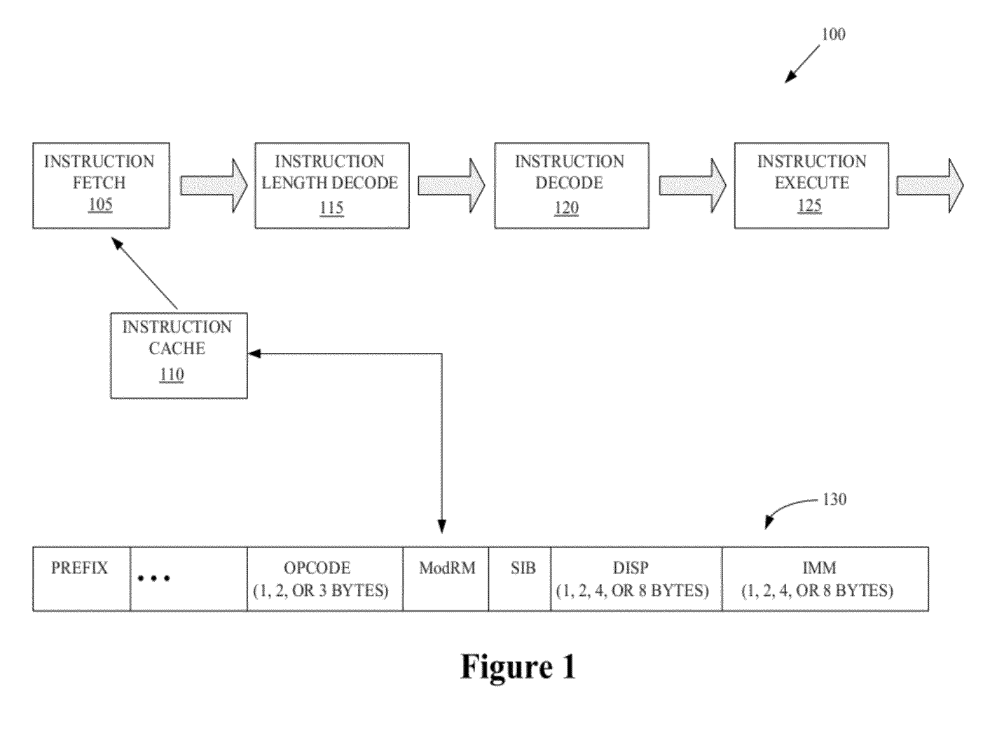

FIG. 1 conceptually illustrates one exemplary embodiment of a processing pipeline 100. In the illustrated embodiment, the pipeline 100 includes an instruction fetch stage 105 that is used to fetch instructions from one or more instruction caches 110. For example, the instruction fetch stage 105 can fetch sequential (or non-sequential) fetch windows including a selected number of bytes from the instruction cache 110 such as a 16-byte fetch window. The fetch windows retrieved by the instruction fetch stage 105 can be passed to an instruction length decode stage 115 that can determine the length of the instructions included in the fetch windows, e.g., by parsing the bytes in the fetch windows as discussed herein. The instruction length decode stage 115 can pass the length information to an instruction decode stage 120 that decodes the instructions and provides the parsed instructions to an instruction execute stage 125 for execution. Techniques for implementing and operating a processing pipeline 100 are known in the art and in the interest of clarity only those aspects of implementing and operating the processing pipeline 100 that are relevant to the claimed subject matter will be discussed herein.

One exemplary embodiment of an instruction 130 is shown in FIG. 1. The instruction 130 may include one or more prefixes such as legacy prefixes and/or REX prefixes. Any number of prefixes can be included in the instruction 130 and in some cases the legacy prefixes can modify the overall length of the instruction 130. In the illustrated embodiment, the overall length of the instruction 130 is limited to being less than or equal to 15 bytes. However, persons of ordinary skill in the art having benefit of the present disclosure should appreciate that alternative embodiments may allow the instruction 130 to be larger than 15 bytes or may limit the length to being less than 15 bytes. The basic operation of the instruction 130 is specified by the operational codes or opcodes in the instruction 130. In the illustrated embodiment, the opcode can be specified using 1, 2, or 3 bytes of the instruction 130. Additional bytes may be used to specify which registers or memory addresses the instruction uses as operands (mod register/memory, ModRM, bytes) and scale-index-base (SIB) bytes to specify more complicated addresses, although in the illustrated embodiment these bytes are optional and may or may not be included in the instruction 130. The instruction 130 also includes displacement (DISP) bytes and immediate (IMM) bytes. The instruction 130 can include 1, 2, 4, or 8 bytes to specify the displacement and 1, 2, 4, or 8 bytes to specify the immediate bytes.

The instruction cache 110 forwards fetch windows of instruction bytes to the instruction length decoder 115 via the instruction fetch stage 110. In one embodiment, the incoming instruction fetch windows may be sequential with the previous fetch windows in which case the first instruction starting byte of the new window immediately follows the last instruction byte of the last instruction that started in the previous window. Alternatively, the incoming instruction fetch windows may be non-sequential in which case the incoming fetch window includes a pointer to the first byte of the instruction flow in the non-sequential window. Although the instruction cache may forward a pointer to bytes in the incoming non-sequential fetch windows, the pointer can be converted to a mask prior to being flopped and used in the instruction decoder, as discussed herein. From that point forward through length decode, the instruction decoder uses masks, which may be referred to herein as start masks, throughout the decoding process to reduce or eliminate encode/decode delays associated with pointers.

The instruction length decode stage 115 may concurrently determine different masks identifying bytes that make up different candidate instructions drawn from the fetch window. For example, the length decoder for each byte position may hold lengths not just for the first instruction, but for any instructions (including subsequent ones) that would start on a byte of the window, e.g., the length decode information may be good for all potential instructions in the fetch window. Each of the masks uses a different byte in the fetch window as a starting byte. For example, the instruction length decoder 115 may perform parallel decodes on every incoming instruction byte of the incoming windows to determine the number and type of x86 prefixes (including those whose value can alter instruction length), the relative position of the first operational code (opcode) byte (which may be represented as a pointer, OpPtr) assuming that the incoming byte is the first instruction byte, and prefix-invariant length decode information assuming that the incoming byte is the first opcode byte. This information is then fed forward or multiplexed to final length decoders for every byte position so that the instruction length decoder 115 can select one of the masks to identify one of the candidate instructions as a first instruction, as discussed herein.

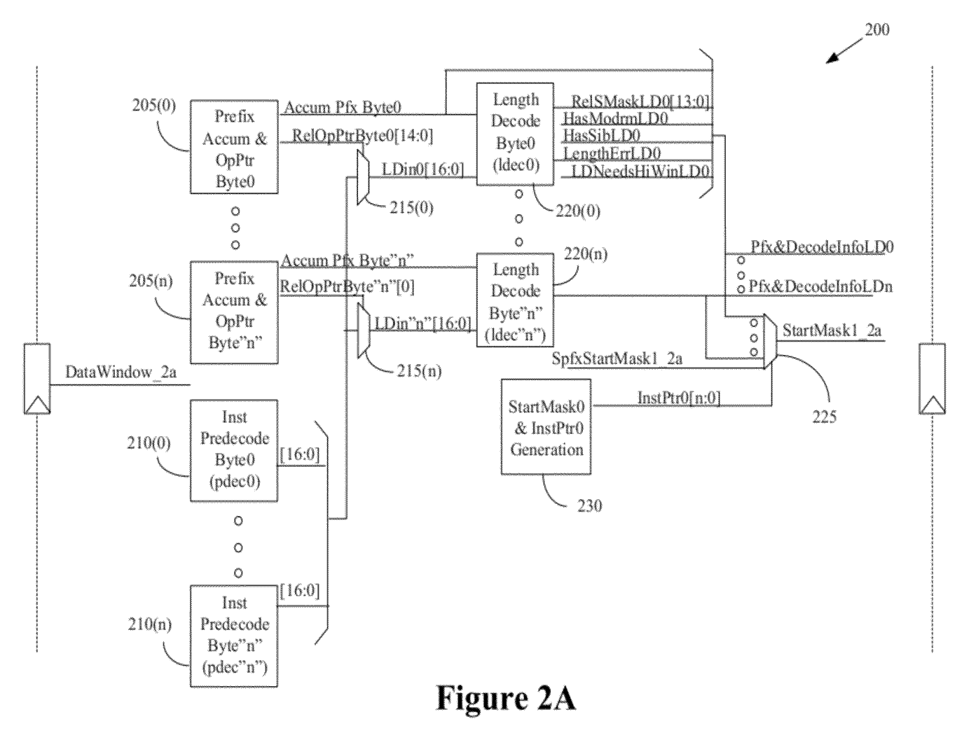

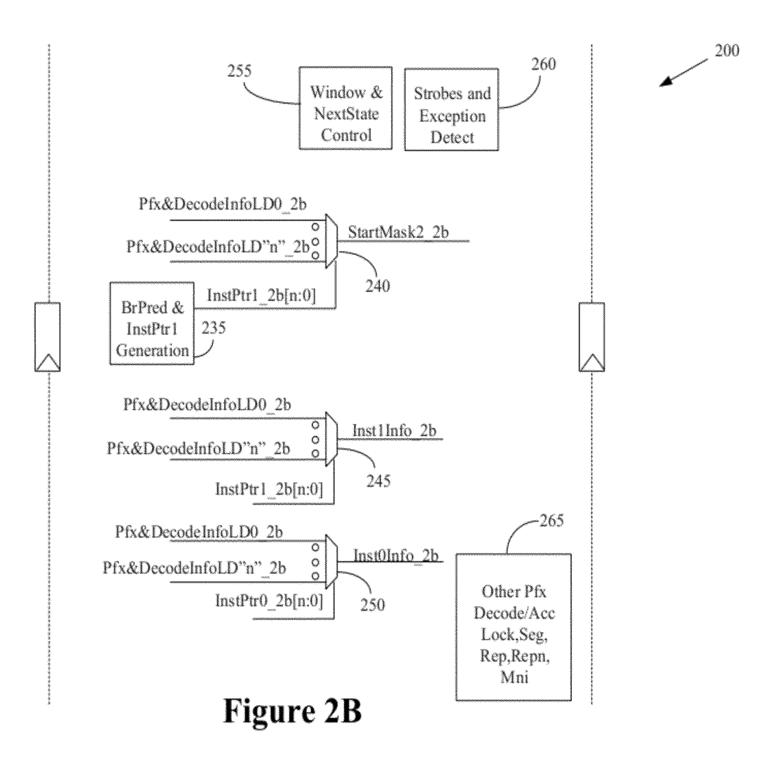

FIG. 2A conceptually illustrates one exemplary embodiment of a first stage of an instruction length decoder 200. In the illustrated embodiment, the first stage of the instruction length decoder 200 receives a data window including instruction bytes. For example, the data window may include a first (or low) fetch window including 16 instruction bytes that have been fetched from a memory or a cache. The data window may also include a second (or high) fetch window that includes instruction bytes that have been fetched from the memory or cache subsequent to the first fetch window in program flow or order. However, in some embodiments, fetch windows that are sequential in program flow or order may not necessarily be sequential in fetch time. In some cases, fetch windows may be processed concurrently or in an order that is different than, opposite to, and/or inverted relative to their program order. For example, two fetch windows can be forwarded to the instruction length decoder 200 in one clock (i.e., concurrently) from a cache line fetch.

The illustrated embodiment of the first stage of the instruction length decoder 200 includes accumulators 205(1-n) that can be used to concurrently process different portions of the data window. One function of the accumulators 205 is to accumulate prefixes for candidate instructions beginning at different bytes in the data window. For example, each accumulator 205 can begin accumulating prefixes starting at a different byte in the first fetch window. Another function of the accumulators 205 is to identify the location of the first opcode byte relative to a starting byte. Each accumulator 205 can generate a pointer indicating the relative location of the first opcode byte relative to a different byte in the first fetch window. In one embodiment, the number of accumulators 205 is selected to be equal to the number of bytes in a fetch window so that each byte in the fetch window can be used as a starting byte for each actuator 205 and all of the starting bytes can be processed concurrently. However, persons of ordinary skill in the art having benefit of the present disclosure should appreciate that alternative embodiments may use different numbers of accumulators 205.

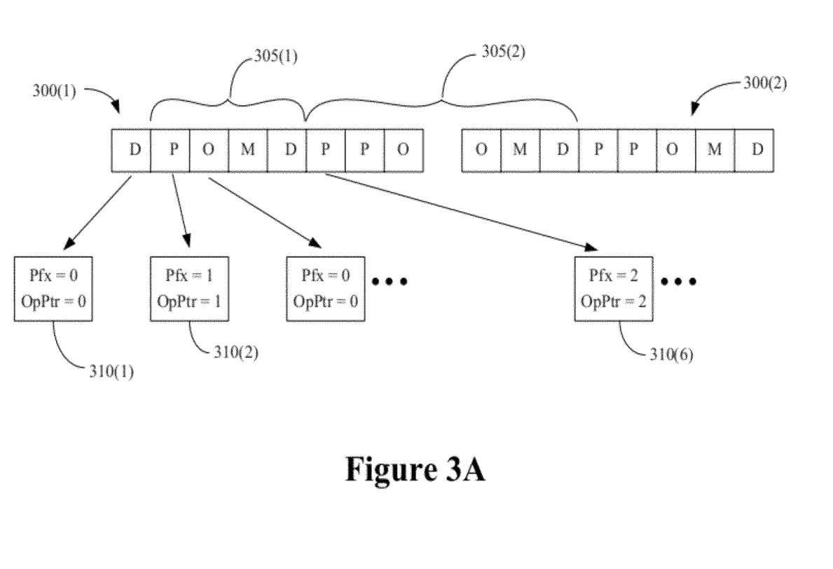

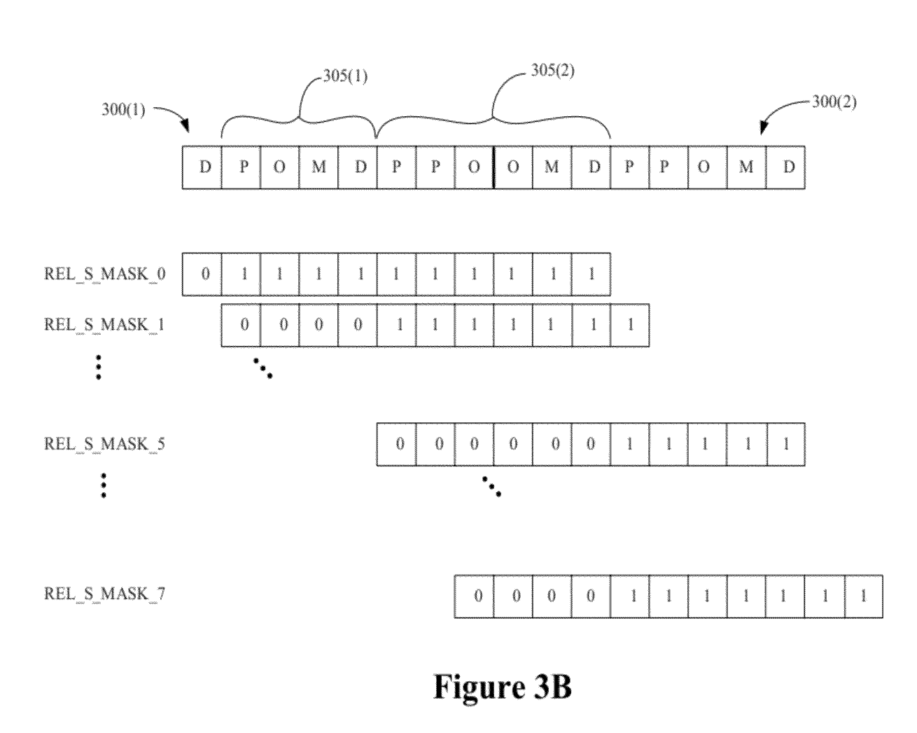

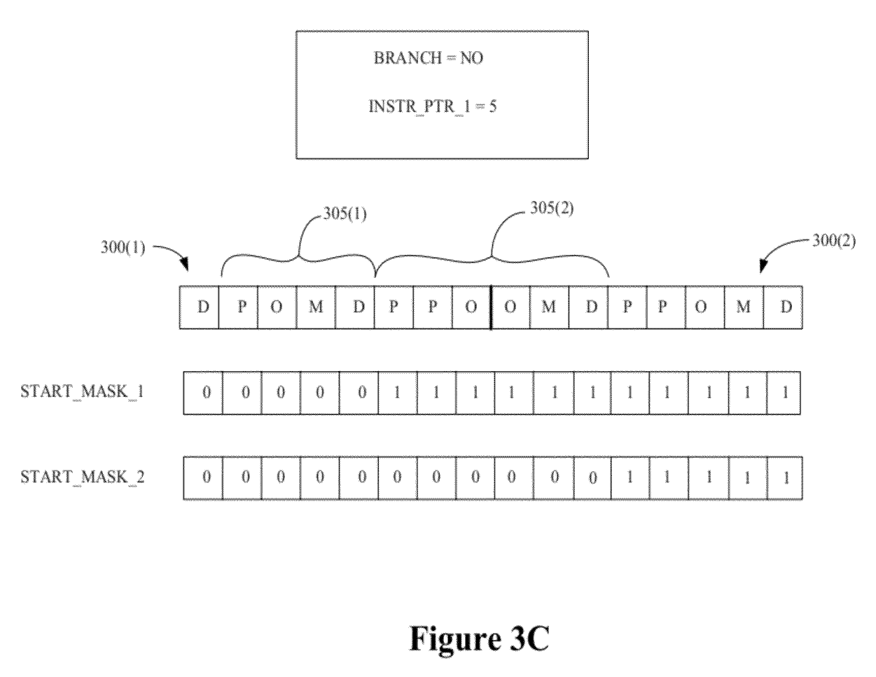

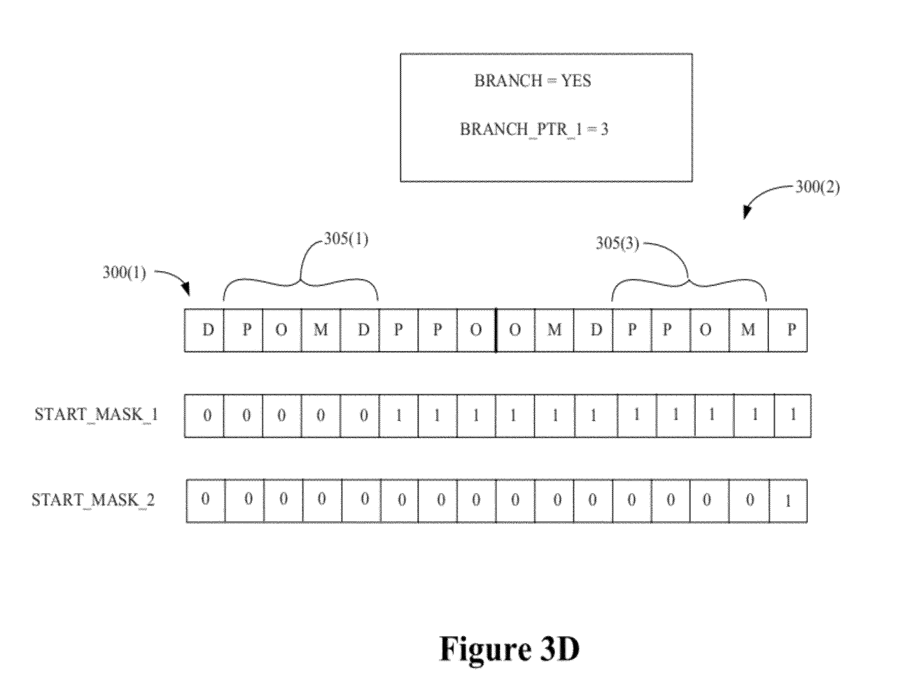

FIG. 3A conceptually illustrates input and output for a bank or array of accumulators such as the accumulators 205 shown in FIG. 2. In the illustrated embodiment, input to the accumulators includes two fetch windows 300(1-2) that each include 8 instruction bytes. Portions of the fetch windows 300(1-2) can form the input to the accumulators. The accumulators concurrently process different sets of instruction bytes beginning at different bytes within the first fetch window 300(1). A first accumulator is configured to process a first candidate instruction that begins at the first byte of the fetch window 300(1). The first byte is a displacement (D) byte associated with a previous instruction and so the first byte is not a valid prefix but it could coincidentally have a value that matches a valid prefix. If the first byte does not match a valid prefix value, then the accumulator does not accumulate any prefix values and assigns the relative OpPtr by starting at the first byte and adding an offset of zero bytes. The accumulator then generates output 310(1) indicating Pfx=0 and OpPtr=0 as shown in FIG. 3A. If the first byte does coincidentally match a valid prefix value, the accumulator accumulates one prefix. The next byte is a prefix (P) of a subsequent instruction and so the accumulator accumulates this prefix, too. The next byte is not a valid prefix and so the accumulator assigns a relative OpPtr to the first byte plus an offset of two bytes. In either case, the number of prefixes and the relative OpPtr are provided to the length decoders even though they are bogus information. This information is not selected as valid information, as discussed herein.

A second accumulator concurrently processes a second candidate instruction that is assumed to begin in the second byte of the fetch window 300(1). The second byte is a prefix of an instruction 305(1). In the illustrated embodiment, the initial start mask points to the second byte as the start of a legal instruction and the second accumulator identifies the second byte as one of a finite set of valid prefix values. The second accumulator can therefore determine that the instruction 305(1) includes one prefix (Pfx=1 in the output 310(2)). The second accumulator also determines that the next byte is an opcode byte and so the pointer is set to OpPtr=1 to indicate an offset of one byte from the current byte. Other accumulators perform the same operations concurrently using other starting bytes.

In the illustrated embodiment, the first instruction 305(1) ends at the fifth byte position and a second instruction 305(2) begins at byte number six. Accordingly, the accumulator that operates on the candidate instruction beginning at byte position six determines that the candidate instruction (which corresponds to the second instruction 305(2)) includes two prefixes and the opcode byte is offset from the starting byte by two bytes. The output 310(6) of this accumulator therefore indicates Pfx=2 and OpPtr=2. Portions of the second instruction 305(2) are also included in the second fetch window 300(2).

Referring back to FIG. 2A, the exemplary embodiment of the first stage of the instruction length decoder 200 may also include instruction pre-decoders 210(0-n). In one embodiment, the number of instruction pre-decoders 210 can be selected to correspond to the number of bytes in the fetch window so that instruction pre-decoding can be performed concurrently on candidate instructions that begin with each byte in the fetch window. However, alternative embodiments of the instruction decoder 200 may include more or fewer instruction pre-decoders 210. The instruction pre-decoders 210 are used to generate prefix-invariant length decode information for each candidate instruction assuming that the starting byte in the fetch window is the first opcode byte of the candidate instruction. Each instruction pre-decoder 210 provides the prefix-invariant length decode information as input to each of a plurality of multiplexers 215(0-n), which are used to multiplex this information to length decoders 220(0-n).

The relative opcode pointer generated by each of the accumulators 205 is used to multiplex information from the instruction pre-decoders 210 to the length decoders 220. As discussed herein, each instruction pre-decoder 210 assumes that its starting byte is the first opcode of the instruction. Using the relative opcode pointer as the input to the multiplexer allows the multiplexers 215 to provide the pre-decoded information that actually satisfies this assumption to the associated length decoder 220. One of the advantages of this embodiment is therefore the utilization of the OpPtr to multiplex the appropriate pre-decoded prefix-invariant length decode information to the length decoders 220 because the length decoder 220 for each byte position assumes that the byte position is the first byte of the instruction. Each of the accumulators 205 also provides the determined number of prefix bytes to the corresponding length decoder 220.

The length decoders 220 can concurrently perform length decoding of different candidate instructions that begin at different bytes within the fetch window. Outputs of the length decoding operation include information indicating whether the candidate instruction includes ModRM or SIB bytes (HasModrm, HasSib), an error estimate (LengthErr), whether the instruction includes bytes in the second (high) fetch window (NeedsHiWin), and the like. Each length decoder 220 also generates a relative start mask that masks off the bytes in the candidate instruction. In the illustrated embodiment, the length decoders 220 can concurrently compute the length of the instruction that would start at the length decoder's assumed starting byte position and then output a start mask relative to the starting byte position. In one embodiment, the length decoders 220 can account for prefix information that may alter the prefix-invariant length decode information, e.g., one of the accumulated prefixes could change the immediate length from 4 to 8 bytes. The start mask shows where that instruction ends and the next instruction begins. For example, a start mask may be a bitwise mapping of byte positions in the instruction window with 0′s on the low order bits prior to the next instruction start and 1′s from the start of the next instruction to the end of the window. The relative start masks can be extended to generate absolute start masks that show absolute instruction boundaries for each byte position. In the illustrated embodiment, the start mask includes the same number of bytes as each fetch window.

FIG. 3B conceptually illustrates generation of relative start masks using the fetch window 300(1-2). The relative start masks can be generated by length decoders, such as the length decoders 220 shown in FIG. 2A, and the relative start masks have a length that corresponds to the maximum instruction length supported by the instruction length decoder. In the illustrated embodiment, the first byte corresponds to the last byte of a previous instruction. As discussed herein, the first byte may coincidentally correspond to the value of a valid prefix. If the first byte does not correspond to the value of a valid prefix, then the relative start mask for this candidate instruction may be generated by the length decoder for byte position 0, evaluating the “D” byte and subsequent bytes as a potential instruction with its first opcode byte being “D”. If that length decode evaluates to a one-byte instruction then the relative start mask for this candidate instruction (REL_S_MASK_0) has a first bit set to “0” and the remaining bits set to “1” to show that only the first byte of the fetch window 300(1) is included in this candidate instruction. If the first byte coincidentally corresponds to a valid prefix value, then the first five bits of the relative start mask for this candidate instruction (REL_S_MASK_0) are set to “0” and the remaining bits are set to “1.” This bogus information should not affect operation of the stage because it should not be selected.

A second length decoder performs length decoding on a candidate instruction that begins on the second byte (byte position 1) of the fetch window 300(1). The first instruction 305(1) begins at the second byte and so the length decoder outputs a relative start mask (REL_S_MASK_1) for this starting byte that includes “0”s in the first four bits to indicate that the first four bytes (beginning at the second byte of the fetch window 300(1)) are included in the candidate instruction, which corresponds to the first instruction 305(1).

In the illustrated embodiment, the second instruction 305(2) begins at byte position 5 in the first fetch window 300(2). A corresponding length decoder therefore outputs a relative start mask (REL_S_MASK_5) that includes “0”s in the first six bit positions to indicate that the second instruction 305(2) includes the last three bytes of the first fetch window 300(1) and the first three bytes of the second fetch window 300(2). The remaining bit positions in the relative start masks are set to “1” to mask off these bytes in the second fetch window 300(2). The other length decoders may also output relative start masks for other candidate instructions. However, in the illustrated embodiment, these other candidate instructions may not correspond to actual instructions.

Referring back to FIG. 2A, each length decoder 220 provides the length decode information, including the start mask, as input to a multiplexer 225. For example, zeros can be concatenated to the beginning of the relative start masks generated by the length decoders 220 to form absolute start masks. The number of concatenated zeros corresponds to the byte position of a candidate first instruction byte so that the relative start mask is converted into a candidate absolute start mask. Concatenation of the zeros can be performed using a shift-right, zero-fill of the relative start mask value by its byte position. The candidate absolute start masks from each of the length decoders 220 can then be provided as inputs to the multiplexer 225. The exemplary embodiment of the first stage of the instruction length decoder 200 also includes a generator 230 that can be used to generate initial start masks and/or initial instruction pointers. For example, generator 230 can be configured to generate or access a start mask that has been used to mask off a previous instruction, such as an instruction that uses up an initial byte or bytes of the first fetch window in the data window.

The generator 230 may also be able to generate an instruction pointer that points to the beginning of an instruction within the data window, such as the first new instruction in the first fetch window. In one embodiment, the generator 230 can use branch prediction information received along with each fetch window to generate the instruction pointer. The information used as input to the generator 230 may be created during a previous iteration or stage of operations performed by the instruction length decoder 200 and saved in one or more memories, caches, and/or registers. The generator 230 can then provide information, such as the instruction pointer, as input to the multiplexer 225, which can use this input to select one of the candidate absolute start masks as the start mask of the next instruction included in the data window. The multiplexer 225 may provide the selected start mask to a second stage of the instruction decoder 200. Other prefix and/or decode information generated by the length decoders 220 may be flopped and provided to other multiplexers in subsequent stages to avoid this becoming a timing path.

FIG. 2B conceptually illustrates one exemplary embodiment of a second stage of the instruction decoder 200. In the illustrated embodiment, the second stage of the instruction decoder 200 receives the selected start mask, other prefix/decode information, branch prediction information and the like. This information can be provided and/or generated by the length decoders 220 in the first stage of the instruction decoder 200. The selected start mask may be provided to a generator 235, which may use the input information to determine whether or not the first instruction indicates a branch and to generate an instruction pointer that indicates the byte position of the next instruction. For example, if the generator 235 determines that no branches are indicated in the first instruction, then the next instruction should begin in the first byte following the last byte of the first instruction. The generator 235 may therefore generate a pointer that indicates the location of the first byte of the next instruction. For another example, the generator 235 can generate a pointer that indicates the location of the first byte of the next instruction indicated by a branch when the generator 235 determines that the first instruction branches to another location in the data window.

The exemplary embodiment of the second stage of the instruction decoder also includes a multiplexer 240 that uses the pointer generated by the generator 235 to select prefix/decode information generated by the length decoders 220. The prefix/decode information generated by the length decoders 220 in the illustrated embodiment includes a start mask corresponding to subsequent candidate instructions that begin following the candidate instruction beginning at the starting byte associated with the corresponding length decoder 220. The start mask selected by the multiplexer 240 corresponds to a start mask of a second instruction subsequent to the first instruction that was identified in the first stage of the instruction decoder 200. Multiplexer 250 can use the same InstPtr0 select signal (delayed by one stage) as multiplexer 225 in the previous stage. The multiplexer 250 can therefore be used to select additional decode information that may be fed downstream to the instruction decoders. Placing the multiplexer 250 one stage later may prevent its output from being a timing path.

FIG. 3C conceptually illustrates selection of the start masks using information provided by a generator, such as the generator 235 showing FIG. 2. Start masks show the position of the remaining bytes in the fetch windows to be considered for length decode. In the illustrated embodiment, the first stage of the instruction decoder has identified the first instruction 305(1) and selected the corresponding relative start mask and converted the relative start mask into an absolute start mask (START_MASK_1). The selected start mask is provided to the generator, which does not detect any branch in the first instruction 305(1). The generator also uses the input first start mask to define an instruction pointer to byte position 5. The instruction pointer is provided to a multiplexer that selects the second start mask from among the start masks provided by the different length decoders in the first stage. In the illustrated embodiment, the instruction pointer to byte position 5 causes the corresponding start mask to be selected as the second relative start mask, which can then be converted into a second absolute start mask (START_MASK_2) that indicates the second instruction 305(2).

FIG. 3D conceptually illustrates selection of the start masks using information provided by a generator, such as the generator 235 showing FIG. 2. In the illustrated embodiment, the first stage of the instruction decoder has identified the first instruction 305(1) and selected the corresponding start mask (START_MASK_1). The selected start mask is provided to the generator, which in this example detects a branch in the first instruction 305(1) that leads to a third instruction 305(3) in the second fetch window 300(2). The generator uses the branching information to define an instruction pointer to byte position 4 in the second fetch window 300(2). The instruction pointer is provided to a multiplexer, which selects another relative start mask from among the relative start masks provided by the length decoders in the first stage. In the illustrated embodiment, the instruction pointer to byte position 4 in the second fetch window 300(2) causes a corresponding relative start mask to be selected and converted to a second start mask (START_MASK_2) that indicates the second instruction 305(2).

One potential advantage of this implementation is the ability to evaluate and forward instructions following a branch in the same clock. In such a case the start mask for a non-sequential window is used to select the length decoder for the instruction 305(3), rather than using the length/end of the instruction 305(1) to select the instruction 305(3). In alternative embodiments, this technique can be extended to support multiple branches indicated in the instructions 305.

Referring back to FIG. 2B, the second stage of the instruction decoder also includes a multiplexer 245 that can be used to select prefix/decode information for the second instruction using the instruction pointer generated by the generator 235. For example, a start mask (such as STARTMASK_1) can be used to generate a pointer (InstrPtr1_{—}2b) that is input to the multiplexer 245 to select length-decoded information for the second instruction to forward to the instruction decoders. Multiplexer 250 may be used to select prefix/decode information for the first instruction using another instruction pointer generated by the generator 235. For example, a start mask (such as STARTMASK_0) can be used to generate a pointer (InstrPtr0_{—}2b) that is input to the multiplexer 250 to select length-decoded information for the first instruction to forward to the instruction decoders.

A window/next state controller 255, logic 260 for detecting strobes and exceptions, and logic 265 for performing other decoding operations may also be incorporated into some embodiments of the second stage of the instruction length decoder 200. This logic in the second stage can therefore evaluate the start masks and/or branch prediction information within a window to determine the start/end of instructions. This information can be used to determine if all the valid instructions within the current fetch window pair are exhausted. For example, a fetch window is exhausted when the start mask indicates that the last instruction byte has been associated with a current instruction. The window controller 255 can then use this information to control input of new fetch windows. Performing the window control computation and pre-decode/length calculation in separate stages of the instruction length decode allows sliding logic between stages to balance the delays and maximize operating frequency. Information output from the first and second stages of the length decoder can be provided to an instruction decoder, e.g., by multiplexing out instructions and forwarding them to the instruction decode modules.

Embodiments of the techniques described herein have a number of advantages over conventional practice. For example, implementing start masks instead of using cached information to identify the beginning and end of instructions can be used to extend the frequency ceiling of dynamic instruction decode so that a lower cost and power part may have a higher frequency of operation. This approach does not require cache and interim storage for or circuitry to manage and update end bits and simplifies the logic used to implement instruction length decoding: For example, embodiments of instruction length decoders described herein do not need to implement multi-mode operation and the instruction generated by the techniques described herein are resident in the instruction decoder prior to evaluation in the instruction decoders, which simplifies exception evaluation and processing.

Embodiments of the techniques described herein may also permit full accumulation of prefix bytes for the instruction and predecode of opcode pointers relative to instruction start bytes. These techniques may also support the use of relative fields throughout the length decode to reduce or minimize the amount of data to be evaluated and the multiplexing required to forward the data. For example, the “width” of the relative fields may be set by the maximum legal instruction length. Embodiments of the instruction length decoders described herein may use parallel predecoded opcode pointers to multiplex parallel predecoded instruction information, which may shorten the length calculation time. The window control logic and the predecode/length decode may be implemented in separate stages, which allows logic to slide between stages to balance the delays and maximize operating frequency. Moreover, combination with branch prediction information may allow further length decodes to occur after branches, yet in the same clock.

Embodiments of processor systems that implement parallel instruction length decoding as described herein (such as the processor system 100) can be fabricated in semiconductor fabrication facilities according to various processor designs. In one embodiment, a processor design can be represented as code stored on a computer readable media. Exemplary codes that may be used to define and/or represent the processor design may include HDL, Verilog, and the like. The code may be written by engineers, synthesized by other processing devices, and used to generate an intermediate representation of the processor design, e.g., netlists, GDSII data and the like. The intermediate representation can be stored on computer readable media and used to configure and control a manufacturing/fabrication process that is performed in a semiconductor fabrication facility. The semiconductor fabrication facility may include processing tools for performing deposition, photolithography, etching, polishing/planarizing, metrology, and other processes that are used to form transistors and other circuitry on semiconductor substrates. The processing tools can be configured and are operated using the intermediate representation, e.g., through the use of mask works generated from GDSII data. For example, the source code and/or intermediate representation can then used to configure a manufacturing process (e.g., a semiconductor fabrication facility or factory) through, for example, the generation of lithography masks based on the source code (e.g., the GDSII data). The configuration of the manufacturing process then results in a semiconductor device embodying aspects of the present invention.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method, comprising:
concurrently determining a plurality of masks identifying bytes in a plurality of candidate instructions, wherein each of the plurality of masks uses a different byte in a first fetch window as a starting byte and the corresponding one of the plurality of candidate instructions includes the starting byte; and
selecting one of the plurality of masks to identify one of the plurality of candidate instructions as a first instruction using information indicating an ending byte of a previous instruction.

2. The method of claim 1, comprising concurrently determining numbers of prefixes in the candidate instructions using a different byte in the first fetch window as a starting byte for determining each number of prefixes in each candidate instruction.

3. The method of claim 2, comprising determining relative positions of a first operational code byte in the candidate instructions using a different byte in the first fetch window for determining each relative position in each candidate instruction.

4. The method of claim 3, comprising determining prefix-invariant length decode information for the different bytes in the fetch window assuming that each different byte is a first operational code byte in a corresponding candidate instruction.

5. The method of claim 4, wherein determining the plurality of masks comprises determining each mask for each different byte using a corresponding number of prefixes, relative position of the first operational code byte, and prefix-invariant length decode information for each different byte.

6. The method of claim 1, wherein concurrently determining the plurality of masks identifying the bytes in the candidate instruction comprises concurrently identifying a plurality of masks identifying bytes in at least one of the first fetch window and a second fetch window that is subsequent to the first fetch window.

7. The method of claim 6, comprising:
routing bytes associated with at least one of the first fetch window and the second fetch window to an instruction decoder using at least one pointer; and
routing decoded information associated with said at least one of the first fetch window and the second fetch window to an instruction decoder using the selected one of the plurality of masks.

8. The method of claim 1, comprising determining a second instruction beginning at a byte subsequent to the last byte in the first instruction, the last byte being determined using the selected one of the plurality of masks.

9. The method of claim 1, comprising determining a second instruction beginning at a byte indicated by a branch in the first instruction.

10. The method of claim 1, comprising fetching an additional fetch window when the selected one of the plurality of masks indicates that the first instruction includes a last byte in the first fetch window.

11. An apparatus, comprising:
means for concurrently determining a plurality of masks identifying bytes in a plurality of candidate instructions, wherein each of the plurality of masks uses a different byte in a first fetch window as a starting byte and the corresponding one of the plurality of candidate instructions includes the starting byte; and
means for selecting one of the plurality of masks to identify one of the plurality of candidate instructions as a first instruction using information indicating an ending byte of a previous instruction.

12. An apparatus, comprising:
a plurality of length decoders configured to concurrently determine a plurality of masks identifying bytes in a plurality of candidate instructions, wherein each of the plurality of masks uses a different byte in a first fetch window as a starting byte and the corresponding one of the plurality of candidate instructions includes the starting byte; and
a first multiplexer configured to select one of the plurality of masks to identify one of the plurality of candidate instructions as a first instruction using information indicating an ending byte of a previous instruction.

13. The apparatus of claim 12, comprising a plurality of accumulators configured to concurrently determine numbers of prefixes in the candidate instructions using a different byte in the first fetch window for determining each number of prefixes in each candidate instruction.

14. The apparatus of claim 13, wherein the accumulators are configured to determine relative positions of a first operational code byte in the candidate instructions using a different byte in the first fetch window for determining each relative position in each candidate instruction.

15. The apparatus of claim 14, comprising a plurality of pre-decoders configured to determine prefix-invariant length decode information for each different byte in the fetch window assuming that each different byte is the first operational code byte in each candidate instruction.

16. The apparatus of claim 15, wherein the plurality of length decoders are configured to determine each mask for each different byte using a corresponding number of prefixes, relative position of the first operational code byte, and prefix-invariant length decode information for each starting byte.

17. The apparatus of claim 16, comprising a second multiplexer configured to provide bytes in at least one of the first fetch window and a second fetch window to an instruction decoder, the second fetch window being subsequent to the first fetch window and said provided bytes being selected using the selected one of the plurality of masks.

18. The apparatus of claim 11, comprising a third multiplexer configured to select a second instruction from the plurality of candidate instructions using input indicating the last byte in the first instruction, the last byte being determined using the selected one of the plurality of masks.

19. The apparatus of claim 18, comprising a generator, and wherein the third multiplexer is configured to select the second instruction beginning at a byte indicated by a branch in the first instruction detected by the generator.

20. The apparatus of claim 11, comprising a window controller configured to fetch an additional fetch window when the selected one of the plurality of masks indicates that the first instruction includes a last byte in the first fetch window.

21. A computer readable media including instructions that when executed can configure a manufacturing process used to manufacture a semiconductor device comprising:
a plurality of length decoders configured to concurrently determine a plurality of masks identifying bytes in a plurality of candidate instructions, wherein each of the plurality of masks uses a different byte in a first fetch window as a starting byte and the corresponding one of the plurality of candidate instructions includes the starting byte; and
a first multiplexer configured to select one of the plurality of masks to identify one of the plurality of candidate instructions as a first instruction using information indicating an ending byte of a previous instruction.

22. The computer readable media set forth in claim 21, wherein the computer readable media is configured to store at least one of hardware description language instructions or an intermediate representation.

23. The computer readable media set forth in claim 21, wherein the instructions when executed configure generation of lithography masks.
